(19) United States
(12) Patent Application Publication
(10) Pub. No.: US 2004/0242322 A1
(43) Pub. Date: Dec. 2, 2004

(54) Flexible user interface

(76) Inventors: Michael Montagna, San Francisco, CA (US); Theodore Yuchiang Cheng, Union City, CA (US)

Correspondence Address: FISH & RICHARDSON P.C., 3300 DAIN RAUSCHER PLAZA, MINNEAPOLIS, MN, 55402, US

(21) Appl. No.: 10/737,490

(22) Filed: Dec. 15, 2003

Related U.S. Application Data
(60) Provisional application No. 60/433,159, filed on Dec. 13, 2002.

(51) Int. Cl. G06F 17/00

(52) U.S. Cl. 463/29

(57) ABSTRACT

Methods and apparatus for generating a user interface definition. A method for generating a user interface definition includes receiving a request for a user interface for a game. The method includes receiving customization data. The method includes identifying resources for inclusion in the user interface based on the customization data. The method includes generating in real time a personalized user interface definition that includes instructions for generating the identified resources. A computer program product for generating a user interface definition includes instructions to cause a processor to receive a request for a user interface for a game. The product includes instructions to receive customization data. The product includes instructions to identify resources for inclusion in the user interface based on the customization data. The product includes instructions to generate in real time a personalized user interface definition that includes instructions for generating the identified resources.

This application claims the benefit of U.S. provisional application Ser. No. 60/433,159, filed on Dec. 13, 2002, which is hereby incorporated by reference in its entirety.

### BACKGROUND

The present specification relates to user interfaces.

In general, applications that interact with users do so through a user interface, which is typically but not necessarily graphical in nature. Applications that administer on-line auctions, for example, provide graphical user interfaces through which one or more users can place bids and be presented with the results of their bids. Casino style gaming applications (or simply, gaming applications) also provide graphical user interfaces, which typically provide users with a gaming environment for a game and allow users to provide input and receive output from the game. A graphical user interface for poker, for example, can include a representation of a gaming table and cards, buttons, and controls for choosing a wager and selecting cards, a display of a user's currency balance, as well as other information about the poker game. The graphical user interfaces of gaming applications are typically robust and can include not only static but also dynamic components.

Gaming applications can provide different types of games of chance, examples of which include, and are not limited to, craps, blackjack, roulette, baccarat, poker, keno, bingo, and progressive jackpots. Systems on which gaming applications are executed, i.e., gaming systems, can take many forms including stand-alone systems, for example, those in a casino, and systems connected through a network, for example, the Internet.

### SUMMARY

The present specification describes methods and apparatus, including computer-program products, for providing a flexible interface.

In general, in one aspect, the invention provides a method for generating in real time a personalized gaming user interface definition. The method includes receiving a request for a user interface for a game. The method includes receiving customization data. The method includes identifying resources for inclusion in the user interface based on the customization data. The method includes generating in real time a personalized user interface definition that includes instructions for generating the identified resources.

In general, in another aspect, the invention provides a computer program product for generating in real time a personalized user interface definition. The product includes instructions to cause a processor to receive a request for a user interface for a game. The product includes instructions to receive customization data. The product includes instructions to identify resources for inclusion in the user interface based on the customization data. The product includes instructions to generate in real time a personalized user interface definition that includes instructions for generating the identified resources. The product is tangibly stored on machine readable medium.

The present invention can be implemented to realize one or more of the following advantages. A system in accordance with the invention can define user interfaces based on user specific data and configurable criteria. Personal data can indicate, for example, a jurisdiction of law to which a user is subject, a geographic location where the user has been verified to be currently located, the user's place of residence, and any combination of the aforementioned. Configurable criteria can specify, for example, which online games or which options are available to a user based on where the user resides and, furthermore, the jurisdiction of law to which the user is subject.

The system can provide a user interface that can be personalized for each user. Personalization can be based on, for example, laws to which a specific user is subject, groups of which the specific user is a member, preferences of the specific user, and previous actions of the specific user. The system can, for example, provide to a user in the United Kingdom a user interface that includes only gaming options that comply with the laws of the United Kingdom. The system does not include, in the user interface, gaming options that are available in other jurisdictions but illegal in the United Kingdom.

The system is configured to personalize user interfaces in real time. In response to user input, for example, a request to participate in on-line gaming, the system can generate a user interface that is personalized for the specific user and for the current request with little latency. If there are changes that occur between a first request and a second request, for example, the specific user changes residency from the United Kingdom to a jurisdiction that permit the above-mentioned illegal gaming options, the system can make the appropriate changes during its personalization process. Here, the user interface for the second request can now provide the gaming options previously omitted because the specific user resided in the United Kingdom.

Personalization can also be performed during run time. Even after an application is started, the system can reconfigure the user interface based on user specific information and configurable criteria. It is not necessary to personalize the user interface before run time. It is not necessary to maintain a user interface definition for each user. Demand on storage space can thus be reduced.

The system is configured so that dynamic objects can be nested in the user interface. One or more Flash movies, for example, can be presented within another Flash movie.

The system can include intelligence to automatically personalize user interfaces. There is no need to manually configure the user interfaces and efficiency is thus improved.

The methods and apparatus can provide a uniform look and feel to the user interfaces provided by an enterprise, even when the user interfaces relate to different applications. The methods and apparatus take a modular approach that allows different user interfaces to share common resources. A single user interface definition engine can create different user interface definitions for multiple users using different computing devices. Moreover, the resources can be generic and as such can be used by different applications, even those from different enterprises. The resources can thus be shared. Furthermore, resources from previous game sessions can be reused in a current game session and the time needed to download resources to a client terminal is thus reduced.

The details of one or more implementations of the invention are set forth in the accompanying drawings and the description below. Other features and advantages of the invention will become apparent from the description, the drawings, and the claims.

### BRIEF DESCRIPTION OF THE DRAWINGS

FIG. 1 shows a system for creating a user interface.

FIG. 2 shows a method for generating a real time personalized user interface.

FIG. 3 shows a game platform.

FIG. 4 shows the game platform implemented over a network.

FIG. 5 illustrates how games are specified.

FIG. 6 shows an error message.

FIG. 7 shows a method for initially loading a game for a user.

FIG. 8 shows a method for assembling a user interface from a Game Definition XML.

FIG. 9 shows a method for updating and configuring a user interface during run time.

FIG. 10 shows an example of a user interface layout.

FIG. 11 shows an example of a user interface for a game.

Like reference numbers and designations in the various drawings indicate like elements.

### DETAILED DESCRIPTION

Methods and apparatus described in the instant application construct, in real time, a flexible and run time configurable user interface. The user interface is implemented as part of gaming applications. Alternatively, the user interface can be implemented as part of other applications where user interaction is desirable or needed (e.g., applications for providing on-line auctions).

The user interface can be generated from a user interface definition (“UI definition”), which can be implemented as an XML document. A programmatic component, for example, a user interface definition engine, creates the UI definition for the user interface by processing a set of parameters through a set of rules in order to select user interface components for inclusion in the user interface. The programmatic component can create the UI definition in real time in response to a user request. Moreover, the programmatic component can create UI definitions that are personalized for each user request.

The UI definition itself can be programmatic—that is, include instructions that can be executed. The UI definition not only can provide instructions from which one or more user interfaces can be generated, but also instructions for responding to user input. The UI definition can be changed during run time, either by the programmatic component or another component. The UI definition can include control definitions that dictate how user interface components are initialized, personalized, and/or displayed. For example, the UI definition can specify the layer of a user interface where a user component is displayed and, furthermore, an order which user interface components are loaded into the user interface. The UI definition can include personalized user information that is used to initialize or control user interface components. The UI definition can include system information, brand information, trademarks, marketing information, and any combination of the aforementioned.

A user interface definition interpreter can interpret the user interface definition and generate the user interface by assembling components based on instructions specified in the user interface definition. The mentioned assembling process can include retrieving user interface components from a networked resource, for example, a Web server or Networked File Structure.

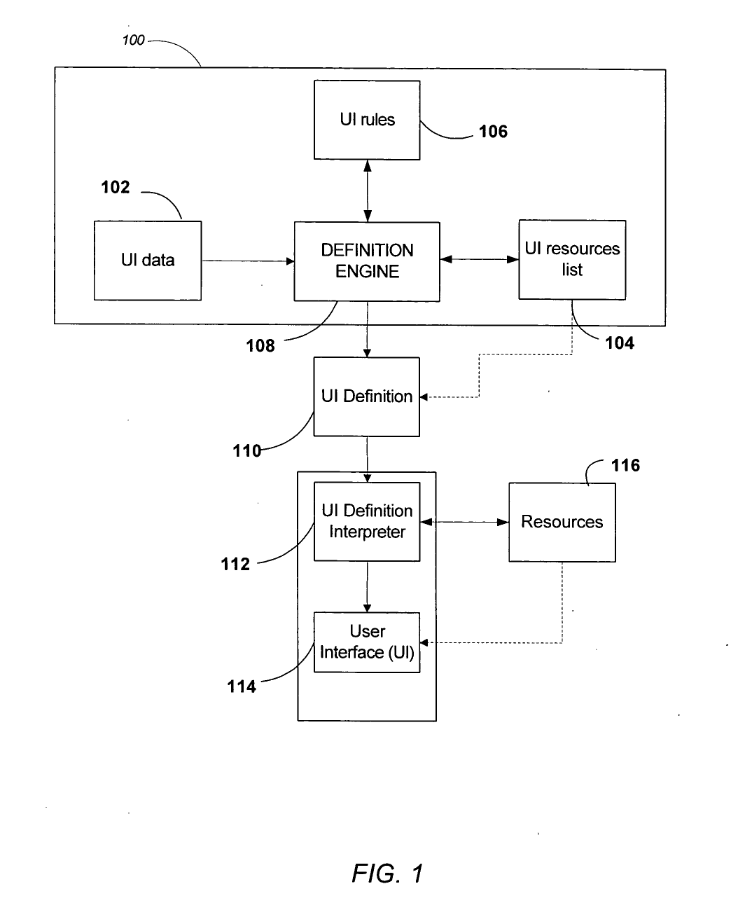

FIG. 1 shows a system 100 for defining a user interface. System 100 includes user interface data (“UI data”) 102, a user interface resource list (“resource list”) 104, user interface rules (“UI rules”) 106, and a user interface definition engine (“definition engine”) 108.

UI data 102 can include data that are related to users, applications for which interfaces will be defined, systems that execute the applications, any combination of the aforementioned, as well as any other data. UI data 102 can include user specific information. The information can indicate, for example, identification for a user, a jurisdiction of law to which the user is subject, a language that the user prefers, and a currency that the user prefers, as well as other user preferences. UI data 102 can also indicate which applications are provided by which enterprise, which applications are available to which users, and which users belong to which group. Grouped users are referred to in the instant specification as a community of users or simply a community. UI data 102 can be stored in one or more relational databases.

Resource list 104 describes resources for generating components of user interfaces. Components of user interfaces can include static user interface objects, dynamic user interface objects, or both. Resource list 104 can include a collection of disparate user interface instructions, referred to in the instant specification as user interface metadata. The user interface metadata can, for example, include any combination of: the names of user interface objects; a position of objects in the user interface; the user interface objects' required controls, functions, and physical appearance (for example, colors); as well as other descriptive identifiers. The user interface metadata can be implemented as XML elements stored in a relational database.

User interface components can be heterogeneous objects of any type, number, or property. User interface components can be stateful and include, for example, buttons, images, or executable code. The nature, location, and features of these components can be determined by previous development, instructions within the described user interface metadata, user interface data, instructions within a UI definition, application code within the user interface components themselves, user interface rules, and any combination of the aforementioned.

UI rules 106 include a set of executable procedures. In general, UI rules 106 specify the form and function of a UI definition. Moreover, UI rules 106 can take the described UI data 102 as parameters to form decisions regarding the construction of the user interface definition. Rules 106 can specify, for example, that given a particular user and a particular enterprise, the UI definition should include instructions that identify certain user interface resources such that the user interface will include components generated by the resources. In gaming, for example, UI rules 106 can dictate which games and game options are available to which users based on the users' jurisdiction.

UI rules 106 can be implemented, for example, with a collection of IF-ELSE statements. UI rules 106 can also be implemented by relationships defined by the above-mentioned relational database. UI rules 106 can be distributed. That is, portions of the rules can be implemented as a collection of IF-ELSE statements while other portions of the rules can be implemented in the relationships defined by the relational databases. UI rules 106 can be configurable. Configuration can be performed through an administrative interface.

Definition engine 108 is a programmatic component. In response to a user request and in real time, definition engine 108 creates a UI definition based on UI data 102, user interface resource list 104, and UI rules 106. Definition engine 108, for example, accesses UI data 102, applies UI rules 106 to the UI data 102, and selects user interface metadata from resource list 104. The selected metadata form the basis of a UI definition. Moreover, the selected metadata can specify a hierarchy between or among user interface components. A user interface component at the root of the hierarchy, for example, is the background of the user interface. User interface components at child nodes of the root are displayed within the component at the root. The selected metadata thus can specify nestings of user interface components. As discussed above, the UI definition can be an XML file.

Definition engine 108 can access UI data 102 through local or remote function calls, inter-enterprise communication protocols, data store queries, session objects, and/or other such information sources. Definition engine 108 can be an application that is executed over a network. Definition engine 108 can also include features to transmit a UI definition, for example, UI definition 110, to a user interface definition interpreter, even one that is remotely located across a network.

A user interface definition interpreter (“UI interpreter”) 112 requests from definition engine 108 and interprets a UI definition to construct a user interface 114. UI interpreter 112 can include the features to request, customize, and display networked user interface components. Typically but not necessarily, UI interpreter 112 runs on an end-user terminal device, for example, a personal computer. The UI interpreter 112 can include a script running within a browser. The script can include logic for interpreting a UI definition and display user interface components in accordance with any specified hierarchy. The script can be sent from the definition engine 108 in response to a user request. The script can act as a shell, for example, within which instructions in a UI definition are executed. The UI interpreter 112 locates resources (e.g., resources 116) in order to assemble the user interface. The UI interpreter 112 can request resources from an external server or can retrieve the resources locally.

User interfaces created as described above (e.g., user interface 114) can include personalized data, metadata, and stateful user interface components. The stateful components can be hierarchically stacked within the UI interpreter 112. When such is the case, one user interface component can load another component within itself, thus creating a user interface with a variable number of component layers. The described hierarchy of elements, objects, or components can usually be specified in the UI definition by the definition engine 108 and, furthermore, provides for run time customization of the user interface.

Together, the UI definition and user interface components can create a single programmatic entity that functions outside of system 100. In gaming, for example, the UI definition can include instructions for providing a complete game with out further interaction with system 100.

The following paragraph describes an implementation in which system 100 generates UI definitions for on-line gaming. UI data 102 is stored on one or more relational databases, which can be positioned at different locations in a network. The data provides user specific information, for example, identity, preferences, membership in communities, gaming history, and jurisdiction to which a user is subject. User interface data 102 also provides jurisdiction information, for example, which jurisdictions allow gaming and legal requirements for participation in on-line gaming. User interface data 102 also provides game information (e.g., rules and pay models of games), casino information (rules of casinos), and community information (e.g., identities of high stake rollers). User interface resource list 104 is implemented as a series of XML records. UI rules 106 are implemented as one or more stand alone and container based applications that can communicate with databases and Web servers. The described applications are also known as Java Beans. UI rules 106 are also implemented by the relationships defined in the relational databases containing the UI data 102. Definition engine 108 is a Java 2 Enterprise Edition (“J2EE”) based application. Alternatively, the definition engine 108 can be any servlet. UI definitions are implemented as XML files. UI interpreter 112 is implemented as a scripting language application. An example of a scripting language is the Flash scripting language available from Macromedia Incorporated. The UI interpreter 112 includes a script to execute instructions in a UI definition, which can include control definitions that specify parameters by which user interface components should be displayed on an end-user display device. The control parameters can specify, for example, the size, color, position, and state of user interface components. The UI interpreter 112 can make HTTP requests to access resources to generate user interface components, determine whether or not the access was successful, and respond accordingly (e.g., provide error message) when access fails.

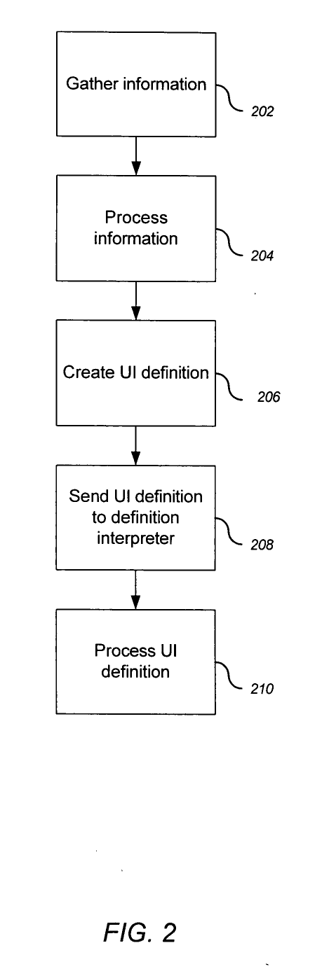

FIG. 2 provides an example of an operation where a personalized user interface for gaming is generated in real time. In response to user input, for example a request to participate in on-line gaming, the definition engine 108 gathers information from a variety of sources, including the above described UI data 102, property files and session information stored in the application cluster's physical memory (step 202). The nature of the information gathered is typically determined by configurable rules (i.e., UI rules 106) and can pertain to the user's state of residence, preferences, language, as well as other system and game information. Once the definition engine 108 has gathered the required information, the definition engine 108 processes the information in accordance with UI rules 106 (step 204), one or more of which dictates the procedure by which the definition engine 108 retrieves a specific collection of user interface metadata from a relational database. The definition engine 108 integrates the gathered information along with the user interface metadata to create the personalized UI definition in response to the current user request (step 206). The definition engine 108 sends the UI definition across a network as an HTTP response object to the UI interpreter 112 (step 208), which executes on an end-user personal computer. The user interface definition interpreter 112 can process the UI definition to create a personalized user interface (step 210).

In the instant example, the UI definition indicates that several user interface components are available at a certain location on a network accessible Web server. The UI interpreter 112 uses internal programmatic logic (e.g., provided by the above mentioned script) to make HTTP requests for the resources needed to generate user interface components. Optionally, certain resources can be available in local cached memory resulting from previous personalized user interfaces. UI interpreter 112 will not have to retrieve these resources. The UI interpreter 112 can use its own internal programmatic logic to search the local cached memory for available resources of user interface components.

Once the user interface component resources are successfully received, UI interpreter 112 continues the execution of the UI definition, which includes control definitions that specify the parameters by which the user interface components should be displayed on the users' display device.

The UI definition includes personalized information specific to the user. The personalized information can be embedded in specified user interface components. For example, the user's name can be downloaded and displayed on the screen in a certain x and y location.

The UI definition can also include logic for determining the states of its user interface components. A user interface icon such as a button, for example, can have multiple states. Once the UI interpreter 112 has finished generating a user interface having components in their appropriate states, the user interface is ready to function with out further input from the system 100. For example, the user interface is ready to accept further user input and interact with a game manager and a random or pseudo-random number generator to provide gaming.

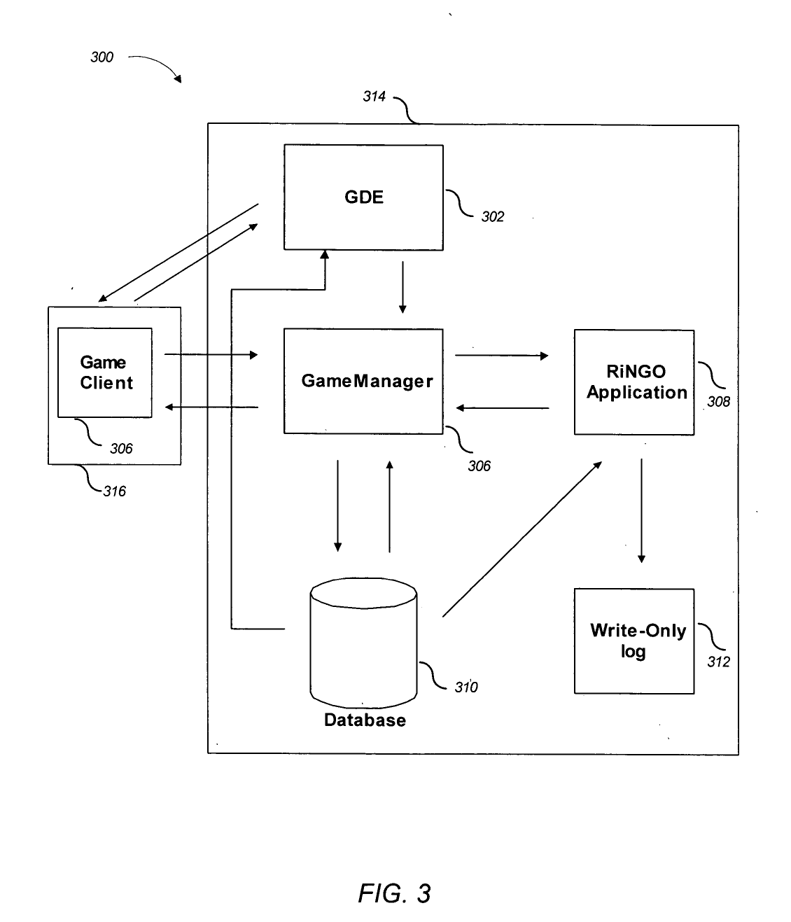

FIG. 3 shows game platform 300 that implements the above-described system 100. Game platform 300 includes a game definition engine (“GDE”) 302, a game client 304, a game manager 306, a Random Number/Outcome Generation application (“RiNGO application”) 308, a database 310, and a write-only log 312. GDE 302, game manager 306, RiNGO application 308, database 310, and write-only log 312 reside on a server 314 while the game client 304 resides on a client terminal 316.

The following provides an overview of the above-listed components of game platform 300. GDE 302 is similar to the above-described system 100. GDE 302 is configured to personalized game delivery to users. Personalization takes into account branding, language, and currency, as well as game logic. GDE 302 is further described below.

Game client 304 collects user input (such as a wager) and communicates it back to the server-side components of the game platform 300. To provide game security, no game logic or win determination occurs in the game client 304 of the game platform 300. Game client 304 includes a master game page, a loader, and a user interface. The master game page can be a browser window that presents a game to a user. The loader is the above-mentioned script that interprets the UI definition and generates the user interface. The user interface provides a visual representation of an application. Game client 304 is further described below.

Game manager 306 provides the server side management of an on-line game. Game manager 306 receives user requests from game client 304 and ensures the user receives appropriate responses. Game manager 306 is responsible for keeping track of game sessions, requesting a game outcome from RiNGO application 306, saving game states in the database 310 for record keeping and refresh, updating the user's account as appropriate for the game state (e.g., debit/credit money), and keeping track of progressive game play if applicable.

RiNGO application 308 generates random numbers and determines game outcomes and wins. RiNGO application 308 is the server side component of the game platform 300 responsible for determining game outcomes. RiNGO application 308 runs games by performing the following tasks: evaluating a client input from game client 304, producing random number, and applying game rules and probabilities to determine game outcomes and wins. RiNGO application 308 performs the listed tasks by processing game instructions held in an XML game description. The XML game description describes all game logic employed to determine an outcome. RiNGO application 308 also includes a random or pseudo-random number generator (“RNG”). The RNG itself is typically ignorant of game logic.

Write-only log 312 is connected to the RiNGO application 308. Outcomes that the RiNGO application 308 generates is logged in write-only log 312. By maintaining redundant outcome records, an operator can compare outcomes in write-only log 312 to those recorded in database 310 to verify that an outcome is legitimate.

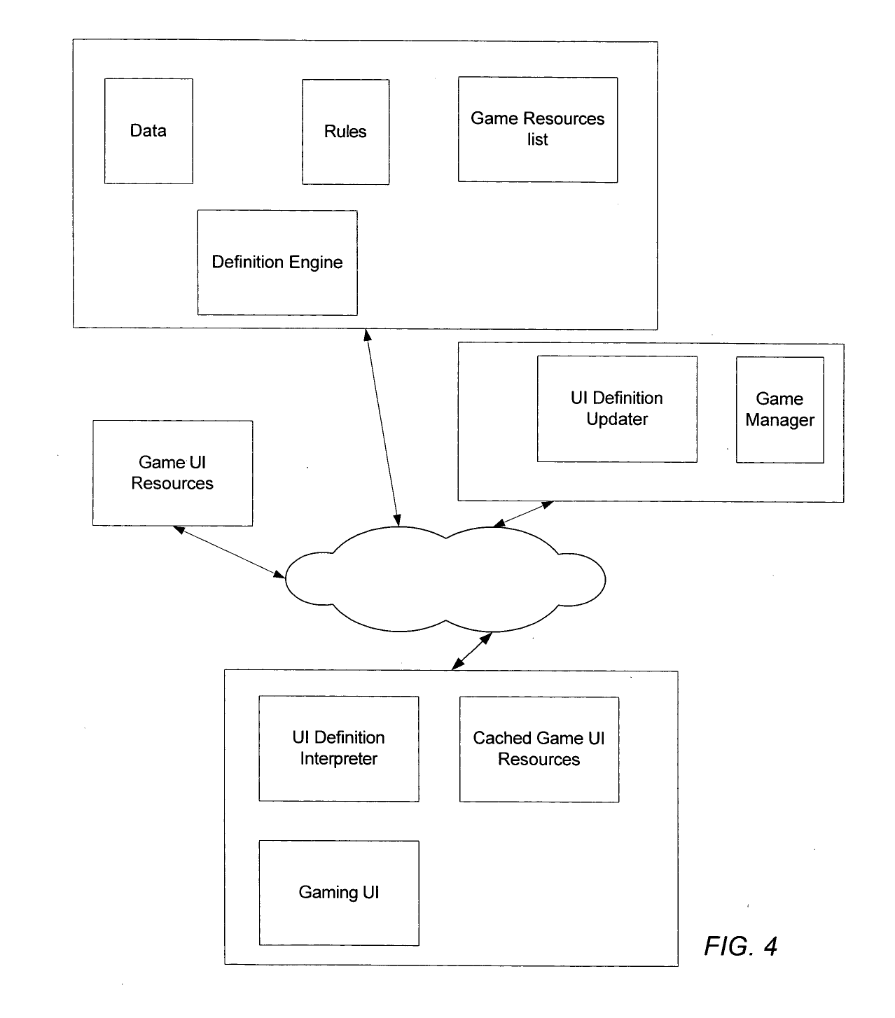

As shown in FIG. 4, game platform 300 can be distributed over a network. The network can be, for example, any combination of: the Internet, a network that includes Wireless Application Protocol (“WAP”) clients, and a network that includes non-browser based clients.

In a typical gaming session, game platform 300 presents a user with a beginning game state, then updates the game state based on user input. The initial game state can be a new game. All subsequent game states reflect the random game outcome determined for a particular user. Game transactions move a user from one game state to the next. Most games consist of either two or three games states. The game platform facilitates the user's request for the next game state, logs each state determination, and updates the user's account as necessary after each state is reached.

For example, in a draw poker game, there are three game states: Initial, Deal, and Draw. The Initial game state represents the state of the game before the user has even played the game. To move to the Deal state the user places a bet and requests five cards. The Deal state represents the first set of cards. To move to the Draw state, the user may hold the cards and request more cards. The game completes in the Draw state, and a win determination is made.

To initialize a new game, the user begins by clicking a hyperlink to select a game from a personalized game menu. The user's browser then loads game client 304. Game client 304 then requests a UI definition from GDE 302. GDE 302 builds and sends to game client 304 a UI definition based on specific user information and configurable criteria as described above with reference to FIGS. 1 and 2. The UI definition includes a list of selected resources. After receiving the UI definition, game client 304 obtains resources necessary to generate a user interface for the selected game. Game client 304 then generates a user interface for the game and the user can initiate game play.

The following provides a detailed description of GDE 302. GDE 302 allows game platform 300 to personalize game delivery. Personalized game delivery includes providing users with games from a specific casino (e.g., on-line brand), in their preferred languages, currencies, and denominations, with specific percentaging models. Personalization can be based on the user's account profile and business rules defined by a casino operator.

GDE 302 dynamically builds, in real time, a UI definition from which the loader can execute to request the appropriate resources (e.g., games assets) and generate a user interface. GDE 302 is also used to ensure a user completes any unfinished games before starting a new game. If a user has an unfinished game, GDE 302 can override the user's selection for a new game, and provides the user with the unfinished game.

One example of a game definition process occurs as follows. A user logs on to an on-line casino. The user's profile indicates the user's currency preference is, for example, United Kingdom Pounds and language preference is, for example, English. GDE 302 accesses user specific information and rules similar to the above-described UI rules to determine which games are available to the user. The user is provided a game menu that can include several versions of each game title, each using different denominations. The user selects a denomination of a game title (such as Phantom Belle, Jacks or Better—£1). GDE 302 then generates and sends to game client 304 a personalized UI definition based on the user selection, user specific information, and rules. Game client 304 loads game assets in the user's preferred language and currency. Concurrently, an XML game description is loaded in the game manager 306 to perform outcome and win determination. After game client 304 receives the UI definition, GDE 302 is no longer used in the game play process. After sending the UI definition to the loader, updates to the UI definition are sent by the game manager 306 (i.e., a game servlet and/or a progressive game servlet).

The following describes how game platform 300, including GDE 302, identifies games. Game platform 300 organizes games into a hierarchy with game type being the most general grouping. Below game type are game families, and below game families are game titles. Each game title can include multiple pay models. Table 1 provides examples that illustrate the hierarchy.

TABLE 1

| Grouping: | Example: | Contains: |
|---|---|---|
| Game type | Poker | Game family |
| Game family | Phantom Belle | Game title |
| Game title | Phantom Belle Jacks or | Pay model ID |
| | Better | |
| Pay model ID | Phantom Belle Jacks or | |
| | Better-001 | |

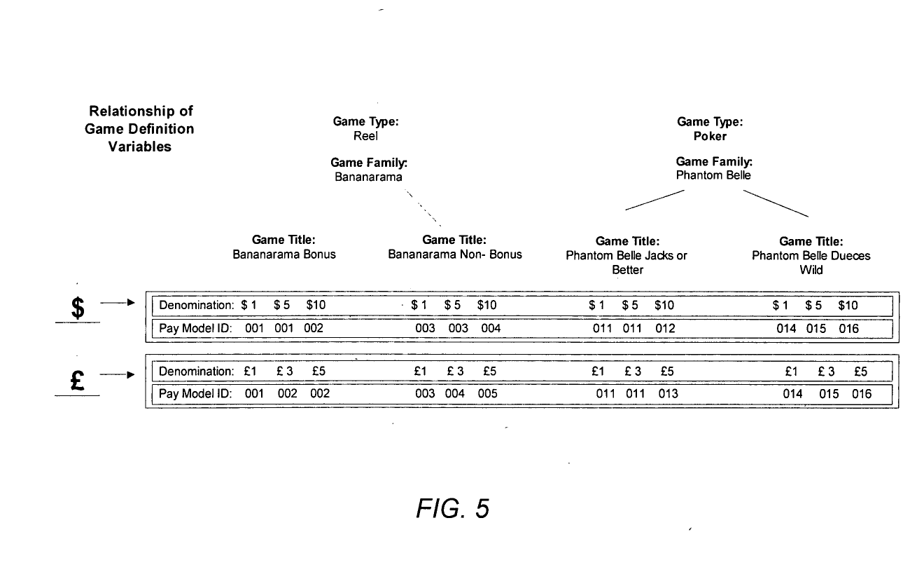

For each currency game platform 300 supports, there is a list of valid denominations. Denomination is essentially the minimum bet. In a quarter slot machine, for example, the denomination is a quarter. Each denomination supported by a game title is associated with a single pay model ID. However, a pay model ID may be used for more than one denomination. Each pay model ID corresponds to a single XML Game Description document. FIG. 5 provides examples that illustrate the relationship of game definition variables and how games are specified.

GDE 302 provides the ability to intelligently deliver to the user the correct game by appropriate selection of client side art assets (e.g., resources for generating dynamic user interface components), denomination, and XML Game Description using rules to evaluate the user's account profile.

GDE 302 delivers games into two phases. In the first phase, the GDE 302 defines a game menu. In the second phase, the GDE 302 defines the game selected by the user. The tasks involved with defining the game menu include: identifying the user and determining user preferences, applying configurations, applying rules to define available game titles and pay models, and checking current jackpot balance if applicable.

The tasks involved in defining the game selected by the user include: defining a UI for selected game and sending the UI definition to a loader.

Each user of game platform 300 has an account and an associated profile. A user's account profile indicates the user's currency and language preferences. When a user requests the game menu, GDE obtains the user's currency preference, and provides a selection of the denominations that are available in that currency. A user's language preference defines the language presented in the UI, which is used later to define the list of required game assets. A user using United Kingdom Pounds, for example, cannot play a game in Euro denominations.

When GDE 302 builds a game menu for a user, GDE 302 takes into account the game configurations, which specify what game titles, denominations, and pay models are available to users. Game platform 300 provides an administrative console that enables casino operators to define and maintain game configurations. A casino operator can define the following: the denominations for each game title and the pay model ID used for each unique combination of denomination, game title, and currency available in a single casino.

GDE 302 applies rules to communities of users. The rules implement business logic. Examples of communities include one that can play all games, one that can play specific game titles with specific denominations (which implies a specific pay model ID), and one that can play no games.

When GDE 302 defines a game menu for a user, GDE 302 takes into account the user's community. If the user is in a community that can only play a specific set of games (with specific denominations and pay models) then the game menu presents only the specific set of games, denominations, and pay models. A casino operator defines rules. The operator can apply rules by using an administrative interface to manually place users into a community.

When a game includes a progressive jackpot, GDE 302 can check the current progressive jackpot balance. When GDE 302 builds the game menu, GDE 302 communicates with a progressive display manager to determine which, if any, progressive games are active. GDE 302 sends the progressive display manager the following parameters: currency, denomination, and pay model.

In response, the progressive display manager returns XML data that includes the current progressive jackpot for the specified pay model/denomination combination. The XML data is then passed to a progressive meter included with the game family in the game menu. After the progressive meter loads in the browser, the progressive meter sends a request to the progressive display manager, which replies with the progressive jackpot amount for the current jackpot. The HTML that defines the game menu also includes information indicating the frequency with which the progressive meter should check for updates, and the length of time that progressive meter should wait for a reply.

The game menu contains a single progressive meter for every game title, regardless of how many denominations of that game title offer a progressive jackpot. If a progressive game title offers a progressive jackpot in multiple denominations, only the progressive jackpot associated with the first denomination will be displayed in the meter.

In the second phase of game delivery, i.e., the game UI definition phase, GDE 302 defines a user interface for the user selected game. The look and feel of the game user interface for a specific game title is based on the following factors: casino, game title, and language. After the user selects a game title and denomination from the game menu, GDE 302 sends to the loader (which, in the instant implementation is a Flash Game Loader) a list of all the game assets needed to display the game user interface. By taking into account casino, game title, and language, GDE 302 can present the game user interface in the appropriate language and online brand.

A game's user interface may look differently when presented by different casinos. In each language, the text presented in the game user interface will be different, and may need to be re-designed to accommodate longer button names. To accommodate these possible variations in the game user interface, an entirely different set of game assets may be used for each language and casino.

To determine the appropriate list of game assets, the GDE 302 queries a database for the list of game assets needed for a specific combination of casino, game title, and language. The database contains a complete set of predefined asset lists for each combination of parameters. GDE 302 passes the list obtained from the database query along to the Flash Game Loader in the ASSETS element of the UI definition (an XML document that defines the user interface for a requested game, referred to as a Game Definition XML).

As discussed above, GDE 302 sends a Game Definition XML to the Flash Game Loader. The Game Definition XML describes what assets are to be included in the game and how the game UI works. GDE 302 builds the Game Definition XML dynamically out of XML sub-components, depending on the game definition process discussed earlier.

Most of the XML sub-components used to build the Game Definition XML are fixed, however certain portions are generated dynamically. Fixed components of the XML are retrieved from the database; dynamic portions are pulled from the XML Game Description, user profile, the user's game state, and, for progressive games, a progressive gateway.

Table 2 provides an example of high-level elements of a Game Definition XML and, furthermore, describes the source of each of the high-level elements.

TABLE 2

| High-Level Element | Source |
|---|---|
| PAYTABLE | Built from XML Game |
| | Description. |
| ASSETS | Stored in database. A unique set |
| | of assets is available for every |
| | casino, game title, and language. |
| HELP | Contains URL for an HTML |
| | game help page. |
| ERRORS | Stored in database. A unique set |
| | of assets is available for every |
| | casino, game title, and language. |
| CONTROLDEF | Stored in database. A unique set |
| | of assets is available for every |
| | casino, game title, and language. |
| DATAEXCHANGE | Constant for each game title. |
| INTERFACESTATE | Determined by game state. May |
| | be initial game state determined |
| | by XML Game Description or |
| | saved game state retrieve from |
| | database. A user is always |
| | presented with their last game |
| | state, even if it describes a |
| | complete game. |
| USERPREFS | Determined by saved user |
| | preferences |
| JACKPOTSTATE | Determined both by dynamic |
| | values and static data progressive |
| | game and jackpot instance, |
| | update interval rate, and update |
| | request timeout period are |
| | obtained from the Progressive |
| | Display Manager. |

Table 3 shows the ASSETS portion of an example Game Definition XML. As can be seen, the ASSETS portion includes metadata for three user interface components, implemented as .SWF files. The file named “consoleBackdrop” provides art for a console backdrop. The file named “controls” provides control logic for the user interface. The file named “Sound” provides sound effects for the user interface. Where applicable, the metadata specifies the location of the .SWF, as well as attributes, for example, the depth (i.e., which layer of the user interface) where the user element is to be displayed, the position in the user interface where the user element is to be displayed, and the name of the instantiated user interface component.

The order in which the metadata for three user interface components appear in the Game Definition XML determines the order in which the user interface components are executed by the Flash Game Loader (which is itself implemented as a .SWF file that includes scripts). One or more of the three .SWF files can also include scripts, which inclusion would allow the .SWF file to execute additional .SWF files. Scripting thus allows nesting of .SWF files. Nesting can allow, for example, one Flash movie to be played within another Flash movie.

TABLE 3
<ASSETS>

<BUNDLE aTag=“Game“>

<FILE aFileName=“../../Common/Console/BG/WWI/console

Backdrop.swf?version=##” aDepth=“160” aInstance=“iConsole
BackdropSwf” aX=“450” aY=“0”/>

<FILE aFileName=“..1/../Common/Controls/WWI/controls.

swf?version=##” aDepth=“300” aInstance=“iControlsSwf”/>

<FILE aFileName=“../../Common/ControlPanel/Action

Gaming/Sound/actionConsoleSoundlet.swf?version=##” aDepth=
“140” aInstance=“iSGConsoleSoundletSwf”/>

GDE 302 can ensure that a user completes any unfinished game before allowing them to begin any new game. Game platform 300 can restore any game not completed by a user.

Depending on the circumstance, the system has two possible ways to ensure a user completes an incomplete game. When a user has an incomplete game due to log off or a dropped Internet connection, the user will need to log back on to the site, and will be presented with a dynamically built Game Menu page, the contents of which depend on whether the user has a game in progress.

If the user has a game in progress when GDE 302 builds the Game Menu page, the game menu only includes the unfinished game (a game title and a single choice of denomination). After the user completes the game, the Game Menu page will refresh to include all of the games available in the user's community when the user closes a Master Game page (which, as described above is a browser window).

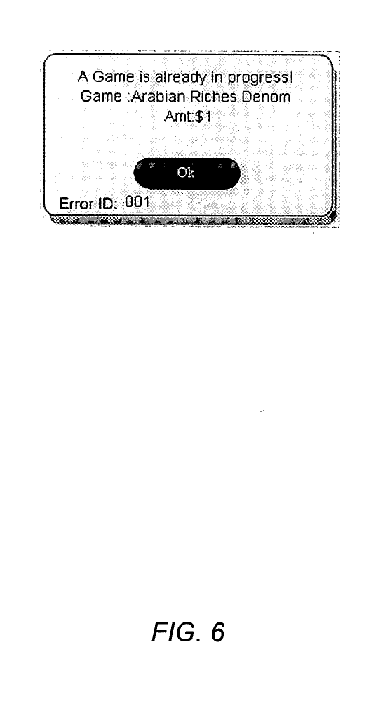

In a different circumstance, game platform 300 uses an error message to ensure the user completes an incomplete game. After a user selects a game from the Game Menu page, the Master Game page opens as a child browser window on top of the Game Menu page. A user could close the Master Game page and attempt to select a new game from the Game Menu page before completing the game. The Game Menu page will still reflect the entire list of games because it would not have been refreshed. To prevent a user from beginning a new game, the system presents an error message indicating that the user has a game in progress that they must finish before beginning a new game. The error message (for example, the one shown in FIG. 6) indicates the game title and denomination of the unfishished game.

When the user clicks the OK button, the game client 304 loads the incomplete game, allowing the user to finish the game. The game UI will reflect the last game state the user reached and depict any outcomes already determined (if the game is multi-staged).

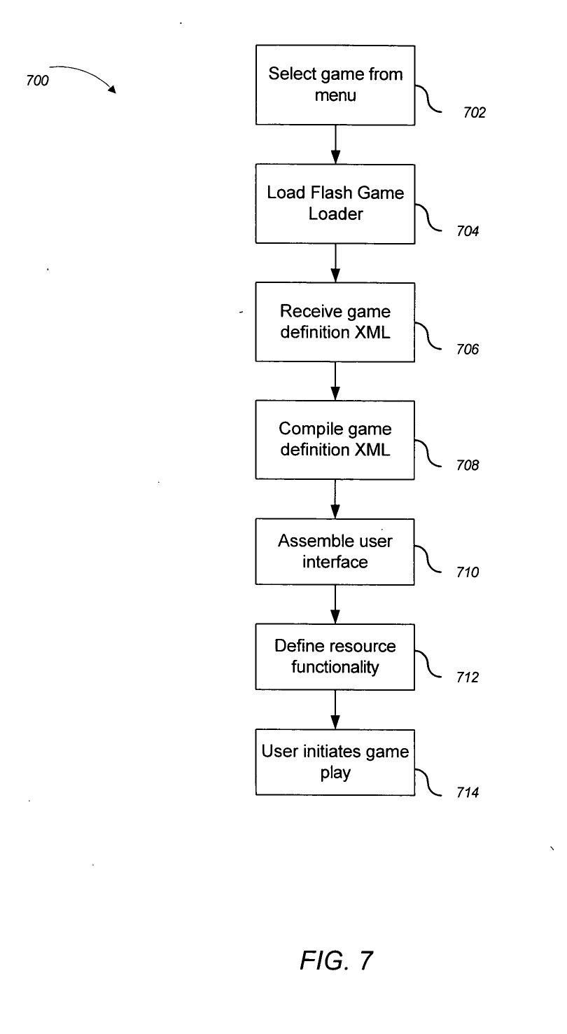

FIG. 7 shows a method 700 for initially loading a game for a user. After logging into a casino system, a user selects a game to play from a game menu (step 702). Based on the existing user profile, the user can be provided with a game menu tailored to the user preferences. The game menu can include a number of different games and denominations from which the user can select. The availability of games can vary depending on the user profile. For example, some jurisdictions may allow some games to be played through online casinos and not others, thus the game menu can vary depending on the location of the user. In another example, the denominations of the games available to a user can vary depending on the user's status as a high-roller in the user profile. After selecting a game a request is sent to the definition engine 208 for a Game Definition XML. Additionally, the Flash Game Loader is loaded into the Master Game page (step 704). The game selected by the user will be presented within the Flash Game Loader. The Flash Game Loader receives the Game Definition XML from the definition engine 710 for the particular game selected (step 706). In one implementation, the Game Definition XML is sent as a compressed file if the user's browser supports g-zip compression. The Flash Game Loader monitors the download of the Game Definition XML and displays a status indicator to the user indicating progress such as percent complete.

The Flash Game Loader then executes the Game Definition XML in order to assemble the user interface (step 708). Assembling the Game Definition XML includes retrieving necessary resources. The resources can include flash movies, class files, and non-flash content such as instructional text for the user in playing the game. Class files are collections of flash ActionScript held in a flash movie file. In one implementation, the resources are downloaded from a gaming server and can be in compressed or uncompressed form.

In another implementation, the Flash Game Loader first checks for locally cached resources before requesting a download of the resources from the gaming server. If a cached resource exists, it is retrieved from the cache. After the resources are retrieved, the Flash Game Loader assembles the user interface (step 710). During assembly, some of the resources can have their functionality defined on the fly by the Flash Game Loader (step 712). For example, a button resource may have generic functionality as a downloaded resource. However, when assembled into a user interface, the button can be defined by the Game Definition XML as it is being integrated into the user interface. The use of generic resources allows for one resource to provide versatile functionality across games. Once the user interface has been assembled, the user can then initiate the game by providing some input to the game manager 306 through the user interface (step 714).

In one implementation, the user interface can be generated to include information for progressive games such as a progressive jackpot total. A progressive game provides an opportunity for a user to win a progressive jackpot under defined circumstances. The progressive jackpot increases with game play until someone wins the progressive. Additional resources can be defined within a Game Definition XML to include a progressive as defined in the above described UI rules 106. A separate progressive servlet can also be used to provide real time updates for Game Definition XML to the Flash Game Loader.

In one implementation, the above described user interface data can include a result of a verification check performed by a verification module. The verification module is generally an application that verifies, among other things, a user's identity and place of residence. Verification usually one or more verification checks. The verification module is further described in commonly assigned U.S. patent application Ser. No. 10/280,895, which is hereby incorporated by reference in its entirety. In the instant implementation, the above described rules can specify which games are available to a user based on results of the verification.

In one implementation, the Game Definition XML includes a root element (a tag called “DNA”). The DNA root element has a number of child elements, including a PAYTABLE, ASSETS, ERRORS, HELP, CONTROLDEF, DATAEXCHANGE, INTERFACESTATE, USERPREFS, and in progressive games, a JACKPOTSTATE element. Each child element provides XML instructions for particular aspects of the user interface. For example, the PAYTABLE element describes the specific pay table for a game to be displayed in the user interface. The ASSETS element defines the source files for a game state or mode, for example, the assets element lists the resources necessary to display the user interface. The CONTROLDEF element defines the game controls for the user interface such as the buttons required for providing user input to the game.

The DATAEXCHANGE element defines what functions the Flash Game Loader should perform in each game state. For example, in poker, a game state can be the “draw” state in which a user can request cards. The DATAEXCHANGE element defines what actions to take in the user interface to draw cards. The DATAEXCHANGE element also defines what functions are called when a game is loaded and defines communication between the Flash Game Loader and other gaming functions. The INTERFACESTATE element is the data exchanged between client and server. The INTERFACESTATE element includes update information for updating the Game Definition XML. For example, in a client-server system, the Game Definition XML updater is used to transmit updated information from the server to the client, such as changes in the account balance of a user after a gaming outcome. If a progressive game is employed, the JACKPOTSTATE element provides basic progressive game configuration parameters for displaying progressive information as part of the user interface.

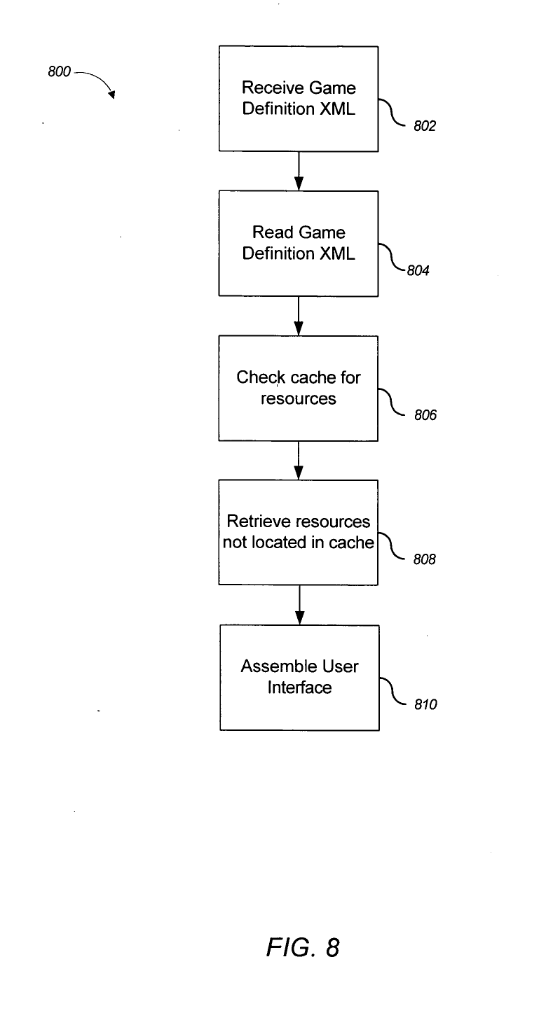

FIG. 8 shows a method 800 for assembling a user interface from the Game Definition XML. The Flash Game Loader receives the Game Definition XML from GDE 302 (step 802). The Flash Game Loader reads the Game Definition XML, which usually includes instructions for generating the user interface (step 804). For example, the Flash Game Loader can read the ASSETS element contained with the Game Definition XML in order to determine which resources are needed to play the game. The Game Definition XML can list resources that need to be retrieved by the Flash Game Loader in order to assemble the user interface. The Flash Game Loader checks local cached memory for the presence of any of the resources specified in the Game Definition XML (step 806). The Flash Game Loader retrieves the required resources not located in local memory (step 808). The resources can be downloaded from one or more servers. The resources usually include Flash objects (e.g., .SWF files). The Flash Game Loader loads the retrieved resources and in accordance with instructions in the Game Definition XML and assembles the user interface (step 810).

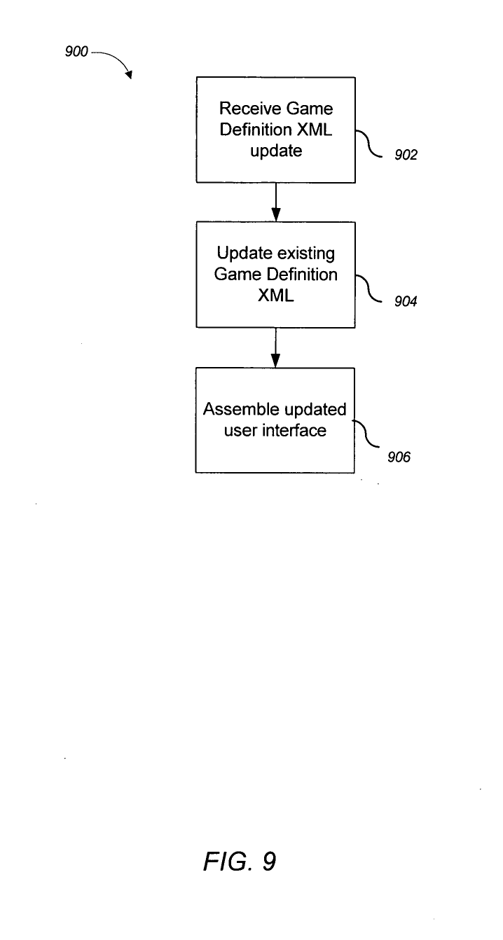

During game play, the game state can change many times based, for example, on user actions and wager outcomes. Whenever the game state changes, the user interface is updated to reflect the change. FIG. 9 shows a method 900 for updating and configuring a user interface during run time. Flash Game Loader receives a Game Definition XML update when game state changes (step 902). In a client-server implementation, for example, the Game Definition XML update can come from the Game Definition XML updater. In one implementation the Game Definition XML updater is a servlet residing on a gaming server that provides information about changes in game state. The Game Definition XML updater can be part of the above described game manager 306.

The Game Definition XML updater can provide real time Game Definition XML updates with each change in game state. For example, based on the outcome of a wager, the user's currency balance needs to be updated to reflect the increased or decreased currency balance. In another example, in a roulette game, after a spin of the roulette wheel the user interface needs to be updated to illustrate the number on which the roulette ball settled. The Game Definition XML updater transmits the update information to the Flash Game Loader to update the user interface.

The Flash Game Loader updates the existing Game Definition XML with the updated information (step 904). For example, the Flash Game Loader can edit one or more of the above described elements of the Game Definition XML to incorporate the update changes.

Flash Game Loader then reloads resources in accordance with the updated Game Definition XML to assemble the updated user interface (step 906). If the Game Definition XML calls for new resources to be downloaded, the Flash Game Loader retrieves the new resources.

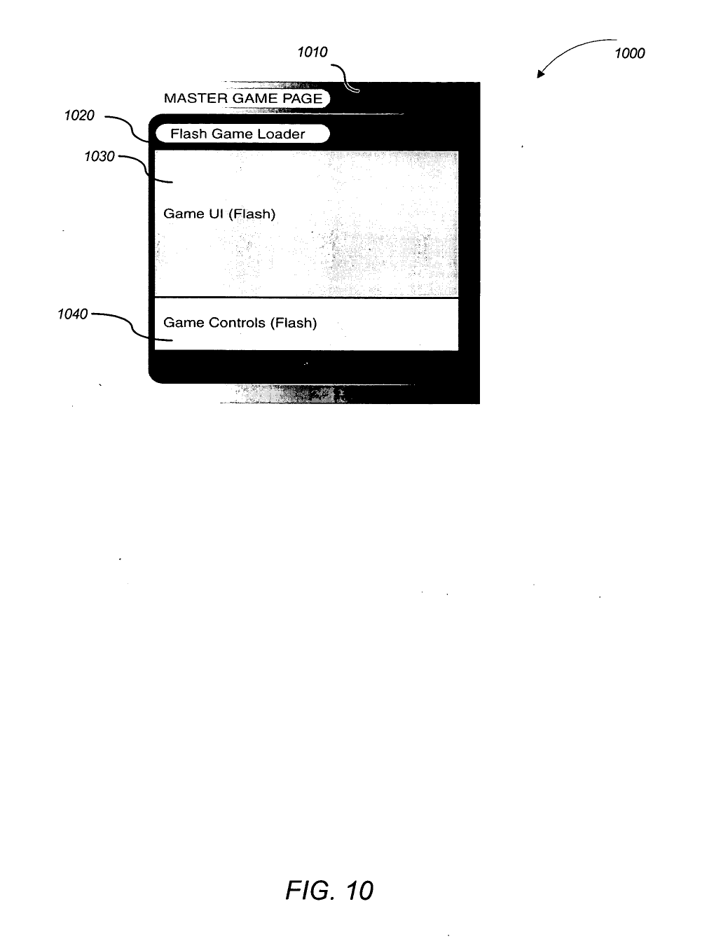

FIG. 10 shows an example of a layout for a user interface 1000. The user interface 1000 includes a master game page 1010, a flash game loader 1020, and a game user interface including flash game UI 1030 and flash game controls 1040. The master game page 1010 can be, for example, a browser window that presents a game to a user. The flash game loader 1020 rests on top of the master game page 1010. The flash game loader 1020 receives and interprets the game definition XML in order to assemble the user interface. The user interface is hierarchical and can be compartmented or stacked with multiple components to provide a user interface. For example, FIG. 10 illustrates a flash game UI 1030 on the top portion of the flash game loader 1020 displaying a particular gaming environment for a user such as a game table, cards, and wagering chips. The flash game UI 1030 can include multiple layers of flash movies. The flash game controls 1040 exist in another field of the flash game loader 1020. The flash game control 1040 can include controls for determining a wager amount as well as for executing play. The flash game loader 1020 can load multiple flash resources on top of each other resulting in a nested user interface. For example, the playing card and the wagering chip resources can be layered upon the resource for the gaming table. In one implementation, a game includes about 20 different flash movies working together to present a user interface. Many flash movies are generic so that many different games can share the same flash resources.

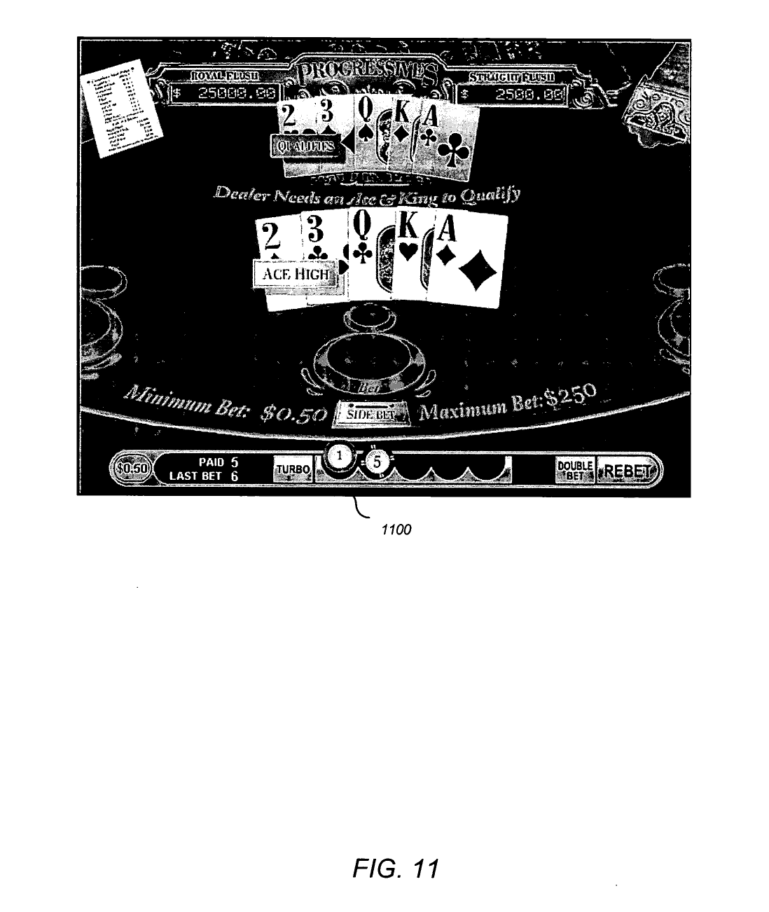

FIG. 11 shows an example user interface 1100 for a progressive jackpot poker game. The flash game controls are located at the bottom of the user interface while the upper portion displays the flash game UI providing the poker playing environment.

The invention and all of the functional operations described herein can be implemented in digital electronic circuitry, or in computer hardware, firmware, software, or in combinations of them. The invention can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The invention can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The invention has been described in terms of particular embodiments. Other embodiments are within the scope of the following claims. For example, the steps of the invention can be performed in a different order and still achieve desirable results. The invention can be applied to applications other than gaming, for example, application relating to on-line auctions. In the latter case, the personalized user interface can prevent, for example, auctions of items that are illegal in a particular jurisdiction while allowing the same items to be auctioned in jurisdiction where they are legal. The described methods and apparatus can be applied to applications other than the described gaming and auction applications. Although user interface components are described as implemented as Flash objects, other type of objects, for example, JAVA objects, Scalable Vector Graphic objects, and C++ objects, can be used to implement user interface components.

What is claimed is:

1. A method for generating in real time a personalized gaming user interface definition, the method comprising:
receiving a request for a user interface for a game;
receiving customization data;
identifying resources for inclusion in the user interface based on the customization data; and
generating in real time a personalized user interface definition that includes instructions for generating the identified resources.

2. The method of claim 1, wherein receiving the customization data includes receiving user profile data.

3. The method of claim 2, wherein receiving user profile data includes receiving user identity, user location, preferred language, and preferred currency:

4. The method of claim 1, wherein receiving customization data includes receiving game data that describes the game.

5. The method of claim 4, wherein receiving game data includes receiving pay model data.

6. The method of claim 1, wherein identifying resources includes identifying one of a flash movie, a text fields, a button, and an image.

7. The method of claim 1, wherein generating a personalized user interface definition includes generating a programmatic user interface definition.

8. The method of claim 7, further comprising:
editing the programmatic user interface definition in response to changes in game state.

9. The method of claim 1, wherein generating a personalized user interface definition includes generating a user interface definition that operates with out further input from a definition engine that generated the personalized user interface definition.

10. The method of claim 1, wherein generating a personalized user interface definition includes generating a user interface definition that is an XML document.

11. The method of claim 1, further comprising sending the personalized user interface definition to an interpreter running on a client computer.

12. The method of claim 1, further comprising interpreting the personalized user interface definition to generate the user interface.

13. The method of claim 12, wherein interpreting includes:
retrieving the resources identified in the personalized user interface definition; and
assembling the resources to create the user interface.

14. The method of claim 12, wherein interpreting includes interpreting with a flash loader.

15. The method of claim 13, wherein retrieving resources includes retrieving resources that are located on a remote server.

16. The method of claim 1, further comprising:
checking a local cached memory for any of the identified resources.

17. The method of claim 1, further comprising:
determining a hierarchy for the identified resources, the hierarchy specifying a nesting of the identified resources.

18. The method of claim 17, wherein the identified resources include flash movies, and wherein determining a hierarchy includes:
determining a hierarchy for the flash movies.

19. The method of claim 1, further comprising
receiving a user interface definition update during run time;
editing the personalized user interface definition to include the user interface definition update; and
interpreting the edited personalized user interface definition to assemble during run time an updated user interface.

20. A computer program product, tangibly stored on machine readable medium, for generating in real time a personalized user interface definition, the product comprising instructions to cause a processor to:
receive a request for a user interface for a game;
receive customization data;
identify resources for inclusion in the user interface based on the customization data; and
generate in real time a personalized user interface definition that includes instructions for generating the identified resources.
